(19) United States
(12) Patent Application Publication
(10) Pub. No.: US 2026/0051844 A1
(43) Pub. Date: Feb. 19, 2026

(54) DAMPER SYSTEM FOR SOLAR PANEL FOUNDATION

(71) Applicant: APA SOLAR, LLC, Ridgeville Corners, OH (US)

(72) Inventors: Josh Von Deylen, Bryan, OH (US); Joseph Von Deylen, Whitehouse, OH (US); Shawn Jeremy Ramey, Ney, OH (US); Erik Steven Shinabery, Bryan, OH (US)

(21) Appl. No.: 19/299,470

(22) Filed: Aug. 14, 2025

Related U.S. Application Data
(60) Provisional application No. 63/682,843, filed on Aug. 14, 2024.

(51) Int. Cl. H02S 20/32; F16F 15/023

(52) U.S. Cl. CPC H02S 20/32; F16F 15/023; F16F 2230/0005

(57) ABSTRACT

The present disclosure relates to a damper attachment system for A-frame foundations in solar tracker systems. The system includes a damper tube having a cylindrical body configured to span between opposing legs of an A-frame foundation, with coped ends comprising flanges that conform to the curvature of round legs and enable direct attachment without requiring additional brackets. The damper tube includes mounting apertures positioned at predetermined points along its length for selective damper attachment and position adjustment. The system optionally includes a standoff bracket having a substantially U-shaped configuration with rotational capabilities about the damper tube circumference, providing additional positioning flexibility and elevation adjustment options. The bracket includes mounting surfaces extending laterally from side panels to create clearance and accommodate various tracker manufacturer specifications.

### CROSS-REFERENCE TO RELATED APPLICATIONS

This application claims the benefit of U.S. Provisional Application No. 63/682,843, filed on Aug. 14, 2024. The entire disclosure of the above application is incorporated herein by reference.

### FIELD

The present technology relates to solar tracker systems and, more particularly, to dampener attachment mechanisms for such systems.

### INTRODUCTION

This section provides background information related to the present disclosure which is not necessarily prior art.

Solar tracker systems represent a sophisticated approach to maximizing energy capture from photovoltaic installations by automatically orienting solar panels toward the sun throughout the day. These systems must accommodate continuous movement while maintaining structural stability and precise positioning accuracy to optimize energy generation performance.

The operational environment for solar tracker systems presents significant engineering challenges, particularly regarding the management of dynamic forces generated by environmental conditions. Wind loading represents one of the most substantial threats to tracker system performance, as it can induce vibrations, oscillations, and unwanted movements that compromise both structural integrity and tracking accuracy. These dynamic forces vary considerably in magnitude and frequency based on geographic location, seasonal weather patterns, local topographical features, and the specific design characteristics of the tracker installation.

Uncontrolled dynamic movements in solar tracker systems can lead to several operational problems. Excessive vibrations may cause mechanical wear of tracking components, reducing system reliability and increasing maintenance requirements. Oscillatory movements can also interfere with the precision positioning required for optimal solar tracking, resulting in reduced energy capture efficiency. In severe cases, unmanaged dynamic forces may cause structural damage or complete system failure.

To address these challenges, engineers have developed various damping solutions designed to absorb and dissipate kinetic energy from unwanted movements. Dampers function by converting mechanical energy into heat through internal resistance mechanisms, thereby reducing the amplitude and duration of vibrations and oscillations. The effectiveness of these damping systems depends on their proper integration with the tracker structure and their ability to respond appropriately to the range of dynamic forces encountered in field conditions.

The implementation of damping systems in solar tracker installations requires careful consideration of mounting locations and attachment methods. Dampers must be positioned at strategic points where they can effectively intercept and control dynamic movements while maintaining secure connections under varying load conditions. The attachment points must provide sufficient rigidity to transfer damping forces effectively while accommodating the operational movements required for normal tracking functions.

Installation and maintenance of damping systems present ongoing challenges for the solar industry. The complexity of integrating dampers into existing tracker designs often requires specialized mounting hardware and custom installation procedures. Field modifications to accommodate damping systems can be time-consuming and costly, particularly when existing structures lack appropriate attachment points or require structural reinforcement to support damper loads.

The need for standardized damping solutions has become increasingly apparent as the solar industry continues to expand and mature. Retrofit applications present particular challenges, as existing installations may lack the structural features necessary to support effective damping systems. The development of adaptable damping solutions that can be readily integrated with various tracker designs and foundation types would provide significant benefits for both new installations and system upgrades.

Accordingly, there is a continuing need for improved damping systems that can provide effective vibration control while offering flexible installation options compatible with diverse tracker configurations and foundation designs.

### SUMMARY

In concordance with the instant disclosure, improved damping systems that can provide effective vibration control while offering flexible installation options compatible with diverse tracker configurations and foundation designs have surprisingly been discovered.

The present technology includes articles of manufacture, systems, and processes that relate to the efficient and adaptable attachment of dampers to foundations in solar tracker systems, facilitating enhanced stability and performance under dynamic environmental conditions.

In one embodiment, a foundation for a solar tracker can comprise an A-frame foundation having a pair of legs and a damper system. The damper system can include a damper tube having a body disposed on each of and spanning between the pair of legs of the A-frame foundation. The damper system can further include a damper with an end disposed on the damper tube and another end disposed on the solar tracker. This embodiment can provide a versatile damper attachment mechanism that allows for easy installation and retrofitting on existing A-frame structures without requiring pre-configured rigid attachment points.

In another embodiment, a method for installing a damper system on an A-frame foundation of a solar tracker can comprise positioning a damper tube across the A-frame foundation, wherein the damper tube can include coped ends with flanges that conform to round legs of the A-frame foundation. The method can further comprise securing the damper tube to the A-frame foundation using fasteners that can pass through apertures in the flanges, through corresponding apertures on either side of the legs, and through opposing flanges. The method can also include aligning a damper with mounting apertures on the damper tube and attaching the damper to the damper tube using fasteners through the mounting apertures.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front perspective view of a solar foundation with a damper system according to one embodiment of the present disclosure.

FIG. 2 is an enlarged perspective view of the damper system of FIG. 1.

FIG. 3 is an enlarged perspective view of the damper system of FIG. 1, depicting an alternative arrangement of offset brackets according to one embodiment of the present disclosure.

FIG. 4 is an enlarged perspective view of the damper system of FIG. 1, depicting an alternative arrangement of offset brackets according to one embodiment of the present disclosure.

FIG. 5 is a front perspective view of a damper system according to another embodiment of the present disclosure.

FIG. 6 is an enlarged perspective view of a damper tube of the damper system of FIG. 1.

FIG. 7 is an enlarged top perspective view of the offset bracket of the damper system of FIG. 1.

FIG. 8 is a bottom perspective view of the bracket of FIG. 7.

FIG. 9 is an enlarged, exploded, perspective view of the damper system of FIG. 1.

FIG. 10 is a flowchart depicting a method of installing a damper system, according to another embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the flexibility and efficiency of installing and maintaining damper systems in solar tracker installations by introducing a versatile damper attachment mechanism that allows for easy adjustments and retrofitting on existing A-frame structures without the need for pre-configured rigid attachment points, significantly reducing the complexity and cost associated with the manufacturing and assembly of solar tracker foundations while also enhancing the ability to customize and optimize the damping system according to specific site conditions and requirements.

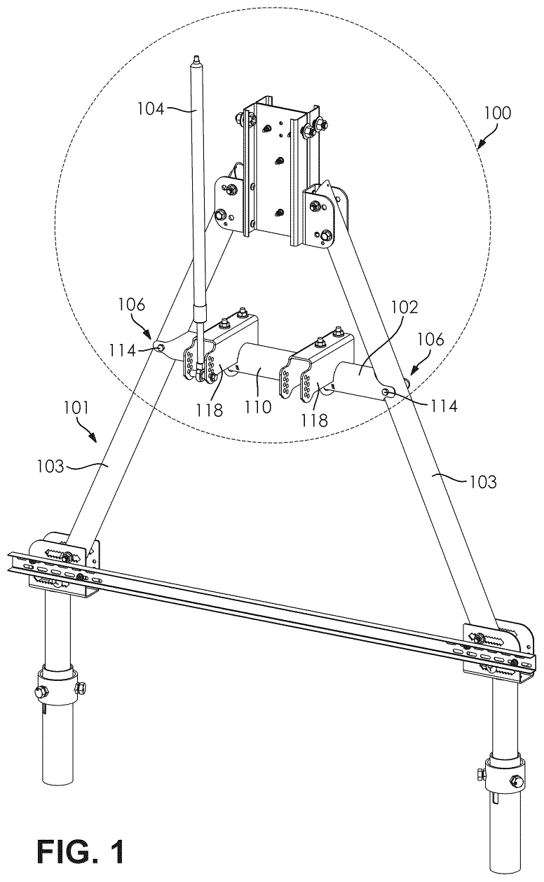

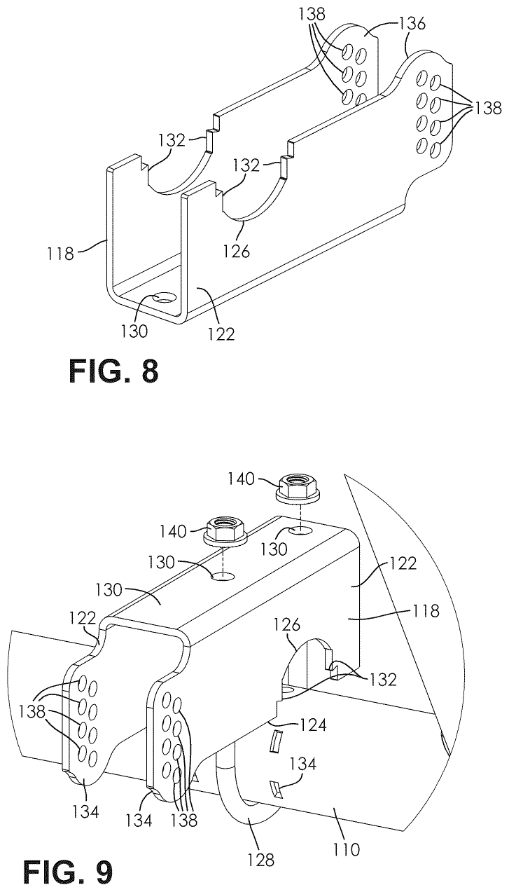

With reference to FIGS. 1-9, a damper system 100 for a solar tracker foundation is shown. The damper system 100 can be utilized with certain solar panel foundations, namely, A-frame solar panel foundations. For example, reference is made to U.S. Pat. No. 12,378,744, granted on Aug. 5, 2025, the entire disclosure of which is incorporated herein by reference. The referenced patent application describes a solar panel foundation system that includes a bracket, braces, and members, which can serve as a basis for the enhancements detailed in this document. It should be appreciated that the damper system 100 of the present disclosure can be utilized within other solar panel foundations within the scope of the present disclosure.

The damper system 100 for an A-frame solar tracker foundation 101 can include a damper tube 102 and a damper 104. The damper tube 102 can serve as a structural connecting element. The damper tube 102 can extend substantially horizontally between opposing legs 103 of the A-frame foundation 101, thereby providing a secure and stable structural interface that facilitates the mechanical connection between the damper 104 and the foundation assembly 101. This configuration can allow the damper tube 102 to distribute loads across both legs 103 of the A-frame structure while creating a mounting platform for damper 104 at the optimal positioning required for effective vibration control. The damper tube 102 can be constructed from structurally suitable materials such as steel or aluminum that can be selected for mechanical properties, including tensile strength, fatigue resistance, and corrosion resistance, to ensure adequate performance when subjected to the environmental stresses and mechanical forces commonly encountered in solar tracker applications, including wind loading, thermal cycling, and dynamic forces generated during normal tracking operations.

The damper tube 102 can include coped ends 106, where each coped end 106 can include two opposing flanges 108. Each of the flanges 108 can extend outwardly from a cylindrical body 110 of the damper tube 102. The flanges 108 can span around a portion of the circumference to conform to the curvature of the legs 103 of the A-frame foundation 101. This spanning configuration of the flanges can allow the damper tube 102 to be positioned at a middle portion of each A-frame leg 103, enabling direct attachment to the A-frame foundation 101 without requiring additional brackets or intermediate mounting hardware. The coping configuration can provide enhanced load distribution along the length of the legs while maintaining structural integrity under dynamic environmental conditions, offering improved structural stability and more centralized load transfer compared to end-mounted configurations. It should be understood the flanges 108 can be formed to accommodate round and other shaped legs of the A-frame foundation, such as oval or square shaped legs, for example.

The coped ends 106 can include an aperture 112 positioned within each one of the flanges 108, where each aperture 112 can be positioned such that a fastener 114 can pass through one flange 108, through corresponding apertures on either side of the leg 103, and through the other flange 108, thereby securing the damper tube 102 to the A-frame foundation 101. The damper tube 102 can be attached using various fasteners 114 including bolts, screws, or rivets, depending on the specific requirements for strength, durability, and case of installation. For example, bolts can offer robust and reliable fastening, particularly effective in environments requiring high structural integrity. A skilled artisan can select suitable fasteners within the scope of the present disclosure.

The damper tube 102 can include one or more pairs of mounting apertures 116, where the mounting apertures 116 of each pair can be aligned across the diameter of the cylindrical body 110 of the damper tube 102. The damper tube 102 can further include an additional pairing of mounting apertures 116 that are generally aligned with the apertures 112 of the flanges 108. The mounting apertures 116 can be positioned at predetermined points along a length of the damper tube 102. The pairs of mounting apertures 116 can allow for selective attachment and adjustment of a position of the damper 104. The damper 104 can be attached to the damper tube 102 using a range of fasteners. A non-limiting example of a fastener includes a bolt that can provide a strong and secure fit that can be easily adjusted or removed for maintenance purposes.

In certain embodiments, for example as shown in FIGS. 1 and 7-8, the damper system 100 can include a standoff bracket 118. The standoff bracket 118 can be configured to provide a correct angle between the damper 104 and a torque tube or other component of the solar tracker system 101, addressing geometry requirements of various tracker manufacturers. The standoff bracket 118 can be particularly useful for tracker systems that have sensitive damper geometry requirements and limited adjustability on the related dampers 104, requiring mounting at specific distances from the torque tube with tolerances of approximately +10 mm. The standoff bracket 118 can allow the damper system 100 to accommodate topography variations at project sites where the torque tube must be mounted at different angles.

The bracket 118 can be substantially U-shaped, having a center panel 120 and a pair of side panels 122 extending from longitudinal edges of the center panel 120. Each of the side panels 122 can have a free bottom edge 124. The free bottom edge 124 can have an arcuate portion 126 that corresponds to the curvature of the cylindrical body 110 of the damper tube 102. The arcuate portion 126 can be positioned off-center so that it is closer to one end of the side panels 122 than the other. Each arcuate portion 126 can receive the damper tube 102 and allow the bracket 118 to be mounted thereto. The bracket 118 can include a U-bolt 128 that can secure the bracket to the damper tube 102. The center panel 120 can include apertures 130 that can receive ends of the U-bolt 128, allowing threaded ends of the U-bolt 128 to pass through the center panel and the closed curved portion of the U-bolt 128 to engage with the damper tube 102 positioned within the arcuate portions 126 of the side panels 122. The arcuate portion 126 of each of the side panels 122 can allow the bracket 118 to be rotated about the circumference of the damper tube 102, enabling the bracket 118 to be disposed at whatever suitable angle is required by the particular installation. The U-shaped configuration of the bracket 118 can create a spacing arrangement where the center panel 120 is positioned at a distance from the cylindrical body 110 of the damper tube 102, with the side panels 122 extending downward to contact the damper tube 102 through their arcuate portions 126. This spacing between the center panel 120 and the damper tube 102 can provide clearance for the U-bolt 128 to pass through the apertures 130 in the center panel 120 and wrap around the damper tube 102 to secure the bracket 118 in position. The spacing between the center panel 120 and the damper tube 102 created by the U-shaped configuration can also provide varying elevations for mounting the damper 104, which can add significant installation flexibility.

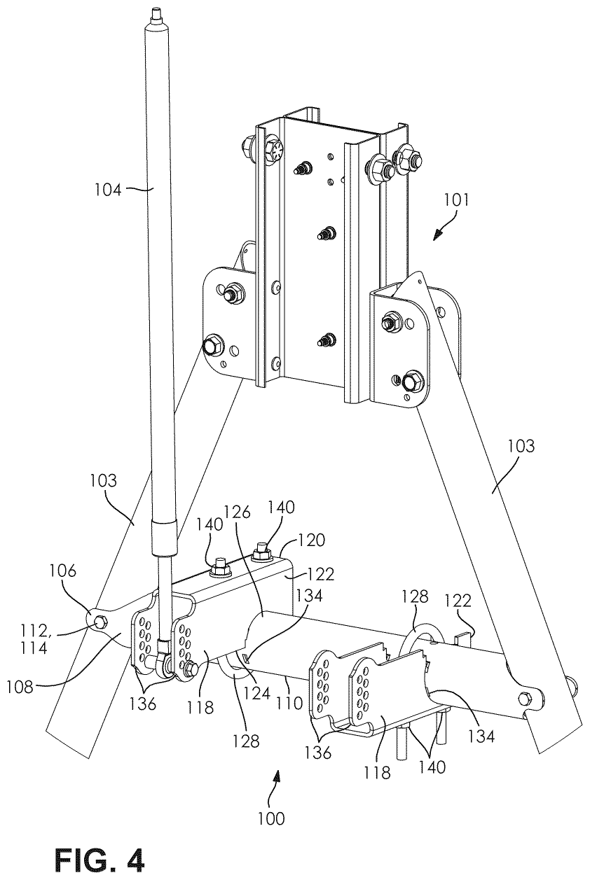

For example, when the bracket 118 is oriented in an inverted or “upside down” position, as shown in FIG. 4, the damper 104 can be mounted at an effectively lower elevation than when mounted directly to the damper tube 102, while maintaining secure attachment through the U-bolt 128 and apertures 130 configuration. This elevation variability can accommodate different site topography requirements and damper positioning specifications without requiring modifications to the damper tube 102 itself. This rotational capability and elevation adjustment capability can accommodate varying site conditions and damper positioning requirements while providing a comprehensive range of mounting options to meet various installation requirements and site-specific conditions.

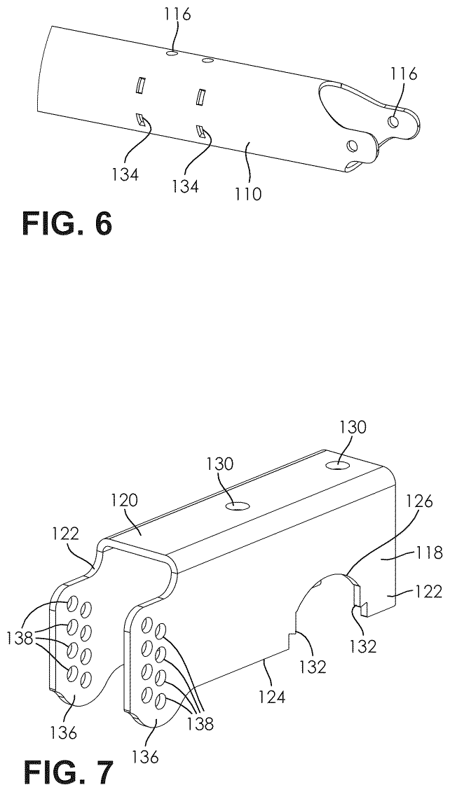

As shown in FIGS. 7-9, the bottom edge 124 of the bracket 118 can include one or more notches 132 on each end of the arcuate portions 126. The notches 132 can angle inwardly from the arcuate portion 126. The notches 132 can correspond to rectangular apertures 134 formed on the damper tube 102 around a circumference thereof, shown in FIG. 6. The engagement between the notches 132 and the rectangular apertures 134 can create mechanical interference that militates against rotation of the bracket 118 relative to the damper tube 102 during operation. This mechanical interference can provide a positive locking mechanism that militates against unwanted movement or rotation of the bracket 118 when subjected to operational forces, vibrations, or dynamic loads encountered during solar tracker operation. The angled inward configuration of the notches 132 can enhance this anti-rotation feature by creating a wedging effect within the rectangular apertures 134, further securing the bracket position and maintaining proper damper alignment throughout the operational life of the system 100.

The bracket 118 can also include a mounting surface 136 extending laterally from a distally located on an end of the bracket opposite the arcuate portions 126 of each of the side panels 122, such that each side panel 122 has a corresponding mounting surface 136. The mounting surfaces 136 can be aligned with each other and can include one or more apertures 138 that align with apertures 138 on the other mounting surface 136 to receive a fastener therethrough for attaching the damper 104 to the bracket 118. The mounting surfaces 136 can provide dedicated attachment points for the damper 104 that are positioned away from the damper tube 102, allowing for secure damper mounting while maintaining the spacing and rotational capabilities of the bracket 118. The lateral extension of the mounting surfaces 136 from the of the side panels 122 can create additional lateral clearance for the damper 104, positioning it to the side of both the damper tube 102 and the A-frame foundation 101. This lateral clearance can prevent interference between the damper 104 and surrounding structural components during damper operation, allowing the damper to function without obstruction from the damper tube 102 or A-frame legs 103. The side-positioned mounting can be particularly important for accommodating dampers with larger profiles or extended operating ranges that might otherwise conflict with the central positioning of the damper tube 102 or the geometry of the A-frame foundation 101. A fastener 140 can pass through each of the mounting surfaces 136 and the damper 104 to rotationally couple an end of the damper 104 to the bracket 118.

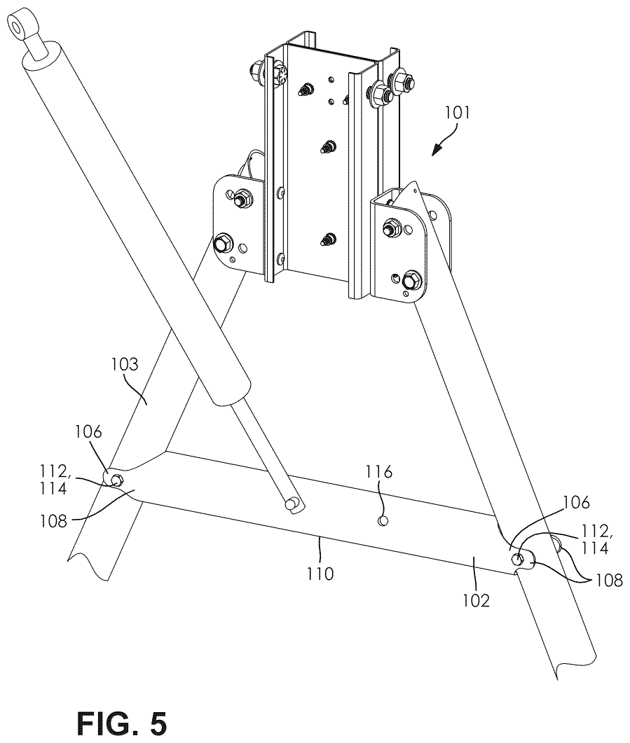

The damper 104 can be attached to either the damper tube 102 directly (e.g., as shown in FIG. 5) or to the bracket 118 (e.g., as shown in FIG. 1), depending on the specific installation needs and requirements of the particular solar tracker system. When attached directly to the damper tube 102, the damper 104 can be secured through the mounting apertures 116 formed in the cylindrical body 102, providing a direct connection that may be suitable for installations with standard geometry requirements. Alternatively, when installation conditions require additional positioning flexibility, geometric accommodation, or lateral clearance, the damper 104 can be attached to the bracket 118 through the mounting surfaces 136 and their corresponding apertures 138. This dual attachment capability allows the damper system 100 to accommodate a wide range of tracker manufacturer specifications, site topography variations, and damper positioning requirements without requiring modifications to the fundamental damper tube 102 design. The selection between direct attachment to the damper tube 102 or attachment through the bracket 118 can be made during installation based on the specific geometric constraints, clearance requirements, and operational parameters of each individual solar tracker installation.

The damper 104 used in the present technology can vary in type, including hydraulic, pneumatic, or viscous dampers, chosen based on the specific damping requirements of the solar tracker. Hydraulic dampers, for example, can utilize a piston and a cylinder filled with fluid to create a damping effect. As the solar tracker moves, the piston pushes against the fluid within the cylinder, and the resistance provided by the fluid absorbs the kinetic energy from the motion, thereby stabilizing the damper system 100. Similar to hydraulic dampers, pneumatic dampers use air instead of a liquid, where the air is compressed within a cylinder to absorb energy from motion. Pneumatic dampers are generally lighter than hydraulic ones and can be easier to maintain in certain environments.

The selection of damper type can depend on various operational factors including environmental conditions, load requirements, and maintenance accessibility. Viscous dampers can provide consistent damping characteristics across a wide range of temperatures and can be particularly effective in applications where smooth, controlled motion is desired. The damping force generated by viscous dampers can be proportional to the velocity of movement, providing predictable performance characteristics that can be tailored to specific solar tracker requirements.

The damper 104 can be configured to accommodate the operational movements required for normal solar tracking while providing resistance to unwanted dynamic forces. The damper can include mounting hardware at both ends to facilitate connection to the damper system 100 and to the solar tracker structure. One end of the damper 104 can be connected to the damper tube 102 or bracket 118, while the opposite end can be connected to moving components of the solar tracker system, creating a force path that allows the damper to control dynamic movements effectively.

Once installed, the damper system 100 works by absorbing the energy from wind-induced movements or vibrations. The damper 104 reacts to these forces by activating its internal mechanisms (e.g., fluid resistance in hydraulic dampers) to slow down and dampen the motion, which reduces the amplitude of vibrations and militates against the vibrations from affecting the stability and orientation of the solar panels. The damping action can be particularly important during high wind conditions where uncontrolled oscillations could lead to mechanical stress, tracking inaccuracy, or potential structural damage. The damper 104 can provide both compression and extension damping, allowing it to control movements in multiple directions and provide comprehensive vibration control for the solar tracker system.

The bracket 118 can provide multiple rotational adjustment capabilities to accommodate varying installation requirements and site conditions. The arcuate portions 126 of the side panels 122 can allow the bracket 118 to be rotated about the circumference of the damper tube 102, enabling the bracket 118 to be disposed at whatever suitable angle is required by the particular installation. This rotational capability can be particularly important for addressing topography variations at project sites where the torque tube must be mounted at different angles, which can change the distance between upper and lower damper mounts.

The bracket 118 can be configured with multiple methods for achieving rotational adjustment. In a rotational method, the bracket 118 can be turned by removing the U-bolt 128, rotating the bracket 118 about the damper tube 102 to achieve the desired angular position, and then re-installing the U-bolt 128 to secure the bracket in the new orientation.

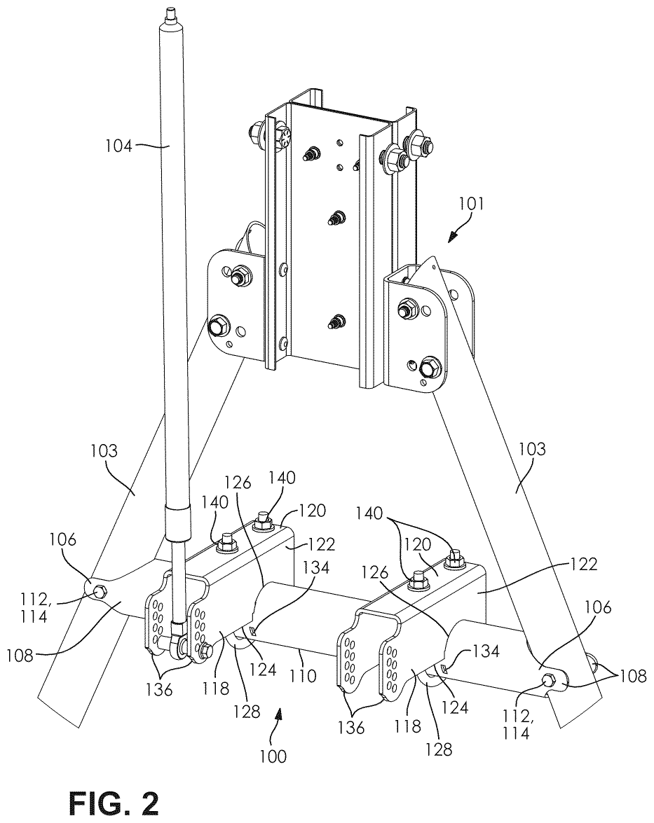

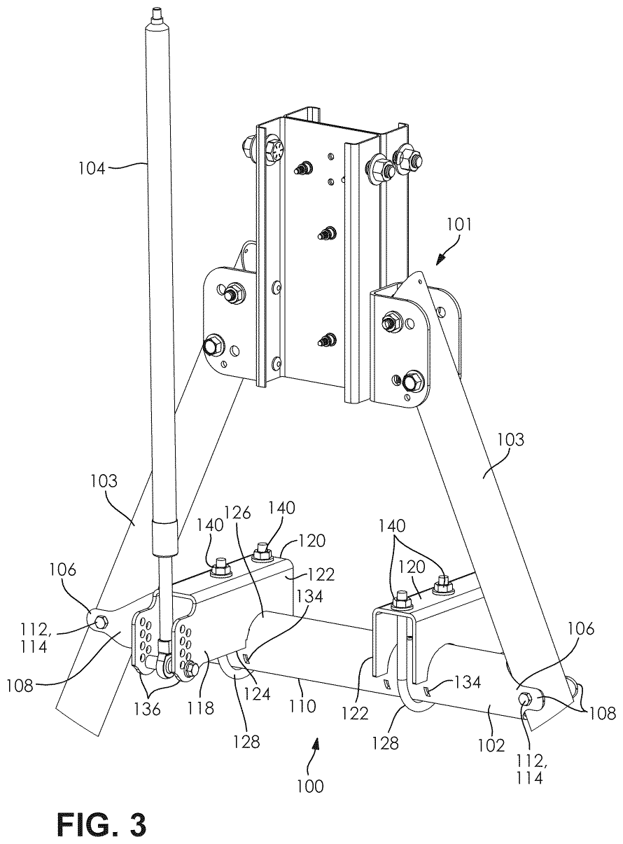

The damper system 100 can accommodate multiple bracket configurations to provide enhanced positioning flexibility. As shown in FIGS. 1-2, the brackets 118 can be aligned in the same orientation for consistent damper 104 positioning, or, as shown in FIG. 4, they can be configured with one bracket in standard orientation and another flipped upside down to provide different elevation options for damper mounting. Additionally, the brackets 118 can be positioned on opposing sides of the A-frame foundation 101 to accommodate different site conditions and geometric requirements, as shown in FIG. 3. This multi-bracket configuration capability can address the requirement that some tracker manufacturers need dampers 104 to be mounted on a specific side of a slope to minimize geometry and clearance issues.

The rotational adjustment capability can reduce the need to orient the A-frame foundation 101 correctly during initial installation, as the bracket position can be adjusted post-installation to meet the specific geometric requirements of different tracker manufacturers. The rotational capability of the bracket 118 about the damper tube 102, combined with the ability to flip the bracket 118 upside down for additional downward adjustment and the option for multiple bracket configurations, can provide comprehensive positioning options to accommodate the sensitive damper geometry requirements that are common in solar tracker installations. This multi-directional and multi-bracket adjustment capability can ensure proper damper 104 alignment and clearance regardless of site-specific topographical challenges or manufacturer-specific mounting requirements.

The damper system 100 can be particularly advantageous in large-scale solar tracker installations where multiple A-frame foundations 101 must be coordinated across varying topographical conditions. In such installations, each individual bracket 118 and A-frame foundation 101 can be independently adjusted to accommodate site-specific topography while maintaining proper damper 104 alignment and functionality across the entire solar tracker system. The flexibility provided by the bracket 118 rotational capabilities can allow each foundation unit within a large installation to be customized for its specific topographical position. The arcuate portions 126 of the side panels 122 can allow each bracket 118 to be rotated about the circumference of the damper tube 102 to achieve the optimal angle required for that particular location within the overall installation. This individual adjustment capability can be particularly important when the torque tube must be mounted at different angles across the installation site due to topography variations, which can change the distance between upper and lower damper mounts for each foundation.

The multi-bracket configuration options can provide additional flexibility for large installations. Different brackets 118 within the same installation can be configured in various orientations-some aligned in the same orientation, others flipped upside down, and still others positioned on opposing sides of their respective A-frame foundations 101—to accommodate the specific geometric requirements at each location. This allows the damper system 100 to maintain consistent performance characteristics across the entire installation despite varying site conditions. The ability to adjust each bracket 118 independently using the U-bolt 128 removal and rotation method, or by rotating the entire mounting assembly, can enable field crews to optimize each damper 104 position during installation without requiring pre-planning of foundation orientations. This post-installation adjustability can significantly reduce the complexity of large-scale installations by allowing the A-frame foundations 101 to be positioned based on structural and logistical considerations, with damper positioning optimized subsequently through bracket adjustment.

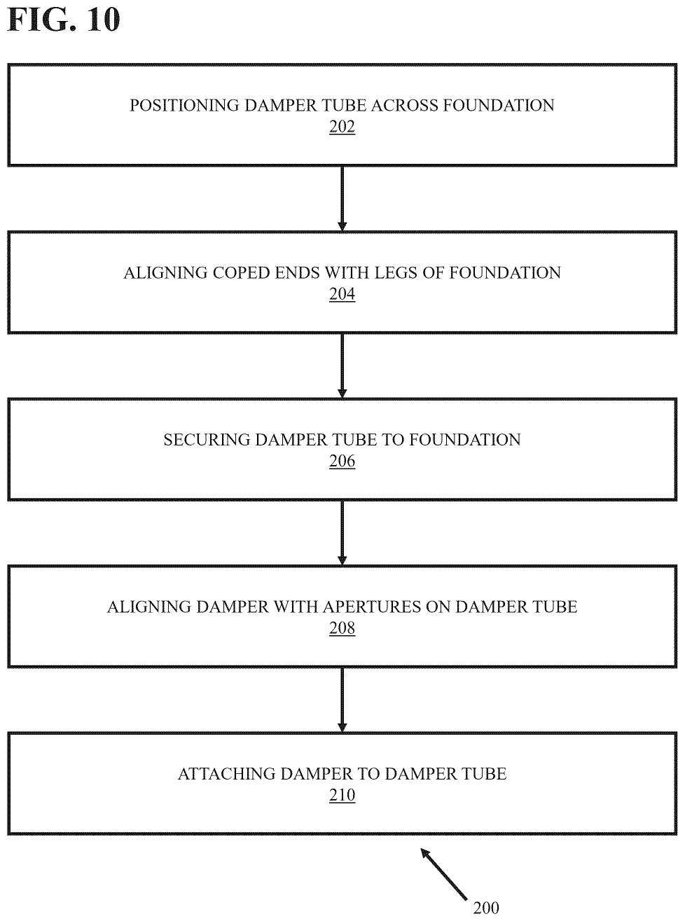

With reference to FIG. 10, a method 200 for installing a damper system 100 on an A-frame foundation 101 of a solar tracker can include a step 202 of positioning a damper tube 102 across the A-frame foundation 101, wherein the damper tube 102 includes coped ends 106 that fit over the legs 103 of the A-frame foundation 101. The method 200 can include a step 204 of aligning the coped ends 106 with the legs 103 of the A-frame foundation 101, ensuring that the flanges 108 of the coped ends 106 conform to the curvature of the legs 103 at a middle portion of each leg.

The method 200 can include a step 206 of securing the damper tube 102 to the A-frame foundation 101 using fasteners 114, where the fasteners 114 pass through apertures 112 in the flanges 108, through corresponding apertures on either side of the legs 103, and through the opposing flanges 108. The method 200 can include a step 208 of aligning a damper 104 with mounting apertures 116 on the damper tube 102, where the mounting apertures 116 are positioned at predetermined points along the length of the damper tube 102.

The method 200 can include a step 210 of attaching the damper 104 to the damper tube 102 using fasteners that pass through the aligned mounting apertures 116. Alternatively, the method 200 can include a step 212 of installing a standoff bracket 118 on the damper tube 102 when additional positioning flexibility is required, where the bracket 118 is secured using a U-bolt 128 that passes through apertures 130 in the center panel 120 and engages with the damper tube 102 positioned within arcuate portions 126 of the side panels 122.

The method 200 can include a step 214 of adjusting the rotational position of the bracket 118 about the axis of the damper tube 102 to achieve the desired angle for the particular installation requirements. The method 200 can include a step 216 of attaching the damper 104 to the mounting surfaces 136 of the bracket 118 using fasteners 140 that pass through apertures 138 in the mounting surfaces 136 and rotationally couple an end of the damper 104 to the bracket 118.

In certain embodiments, the damper system 100 can be provided as a kit 300 for retrofitting existing A-frame solar tracker foundations or for use in new installations. The kit 300 can include the damper tube 102 with coped ends 106 and mounting apertures 116, fasteners 114 for securing the damper tube 102 to the A-frame foundation 101, and optionally the standoff bracket 118 with U-bolt 128 and associated fasteners 140. The kit 300 can allow any A-frame foundation to accept a damper by drilling apertures in the legs 103 and securing the damper tube 102 with fasteners, eliminating the need for specialized A-frame designs during manufacturing. This kit approach can provide comprehensive damper mounting solutions for various solar tracker applications while reducing manufacturing complexity.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A foundation for a solar tracker, the foundation including a pair of legs, comprising:
a damper system including:
a damper tube having a body disposed on each of and spanning between the pair of legs of the A-frame foundation;
a damper with an end disposed on the damper tube and another end disposed on the solar tracker.

2. The foundation of claim 1, wherein the damper tube includes coped ends, each coped end including two flanges extending outwardly from the body and spanning around a portion of an outer surface of one of the legs.

3. The foundation of claim 2, wherein each flange of each of the coped ends includes an aperture formed therethrough.

4. The foundation of claim 1, wherein the damper tube includes a pair of mounting apertures, where each of the mounting apertures of each of the pair of mounting apertures are aligned across a diameter of the body of the damper tube.

5. The foundation of claim 4, further comprising a plurality of pairs of mounting apertures wherein the mounting apertures are positioned along a length of the damper tube, and the pairs of mounting apertures allow for selective attachment and adjustment of a position of the damper.

6. The foundation of claim 1, further comprising a standoff bracket disposed on the damper tube and configured to provide an adjustable angle between the damper and the solar tracker system.

7. The foundation of claim 6, wherein the bracket is substantially U-shaped, having a center panel and a pair of side panels extending from longitudinal edges of the center panel.

8. The foundation of claim 7, wherein each of the side panels has a free bottom edge, and the free bottom edge has an arcuate portion that corresponds to a curvature of the body of the damper tube.

9. The foundation of claim 8, wherein the arcuate portion is positioned off-center so that the arcuate portion is closer to one end of the side panels than the other.

10. The foundation of claim 7, wherein the bracket includes a U-bolt that secures the bracket to the damper tube, and the center panel includes apertures that receive ends of the U-bolt, allowing the U-bolt to pass through the center panel and engage with the damper tube positioned within the arcuate portions of the side panels.

11. The foundation of claim 7, wherein the bracket includes a mounting surface extending laterally from a distally located free edge of each of the side panels, such that each side panel has a corresponding mounting surface, and the mounting surfaces are aligned with each other and include apertures that align with apertures on the other mounting surface to receive the damper therethrough.

12. The foundation of claim 8, wherein the free bottom edge includes notches on each end of the arcuate portions, the notches angle inwardly from the arcuate portion, and the notches correspond to rectangular apertures formed on the damper tube around a circumference thereof, creating mechanical interference that militates against rotation of the bracket relative to the damper tube during operation.

13. The foundation of claim 8, wherein multiple brackets are arranged in different orientations including one bracket in standard orientation and another flipped upside down to provide different elevation options for damper mounting.

14. The foundation of claim 1, wherein the damper is selected from hydraulic, pneumatic, or viscous dampers, and is configured to accommodate operational movements required for normal solar tracking while providing resistance to unwanted dynamic forces.

15. A foundation for a solar tracker, the foundation including a pair of legs, comprising:
a damper system including:
a damper tube having a cylindrical body disposed on each of and spanning between the pair of legs of the A-frame foundation, the damper tube including coped ends at each end thereof, each coped end comprising two flanges extending outwardly from the cylindrical body and spanning around a portion of a circumference to conform to a curvature of the round legs, wherein the flanges are positioned to engage a middle portion of each A-frame leg and include apertures positioned a fastener is disposed through one flange, through corresponding apertures on either side of the leg, and through an opposing flange to secure the damper tube to the A-frame foundation;
one or more pairs of mounting apertures formed through the cylindrical body, wherein mounting apertures of each pair are aligned across a diameter of the cylindrical body and positioned at predetermined points along a length of the damper tube;
a standoff bracket having a substantially U-shaped configuration with a center panel and a pair of side panels extending from longitudinal edges of the center panel, each side panel having a free bottom edge with an arcuate portion positioned off-center and corresponding to the curvature of the cylindrical body of the damper tube, the center panel including apertures configured to receive ends of a U-bolt that secures the bracket to the damper tube, and a mounting surface extending laterally from a distally located free edge of each side panel, wherein the mounting surfaces are aligned with each other and include apertures that align to receive a damper therethrough; and
the damper with an end disposed on one of the damper tube or the standoff bracket and another end disposed on the solar tracker, wherein the damper is selected from hydraulic, pneumatic, or viscous dampers and is configured to accommodate operational movements required for normal solar tracking while providing resistance to unwanted dynamic forces.

16. The foundation of claim 15, wherein the free bottom edge of each side panel includes notches on each end of the arcuate portions, the notches angle inwardly from the arcuate portion, and the notches correspond to rectangular apertures formed on the damper tube around a circumference thereof, creating mechanical interference that militates against rotation of the bracket relative to the damper tube during operation.

17. The foundation of claim 15, wherein multiple brackets are disposed on the damper tube.

18. The foundation of claim 17, wherein the multiple brackets are configured in the same orientation to provide consistent damper positioning.

19. The foundation of claim 17, wherein the multiple brackets are configured in different orientations including one bracket in standard orientation and another flipped upside down to provide different elevation options for damper mounting.

20. A method for installing a damper system on a foundation of a solar tracker, comprising:
positioning a damper tube across the foundation;
securing the damper tube to the foundation using fasteners;
attaching a damper to the damper tube either directly through mounting apertures in the damper tube or through a standoff bracket mounted to the damper tube; and
connecting an opposite end of the damper to the solar tracker.
